(19) United States
(12) Patent Application Publication
(10) Pub. No.: US 2007/0014337 A1
(43) Pub. Date: Jan. 18, 2007

(54) ULTRA-LOW POWER RADIO FREQUENCY DIGITAL RECEIVER

(75) Inventors: Joong Jin KIM, KYUNGKI-DO (KR); Tah Joon PARK, KYUNGKI-DO (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., KYUNGKI-DO (KR)

(21) Appl. No.: 11/457,777

(22) Filed: Jul. 14, 2006

(30) Foreign Application Priority Data
Jul. 15, 2005 (KR) 10-2005-64193

(51) Int. Cl. H04B 1/707

(52) U.S. Cl. 375/151

(57) ABSTRACT

The invention relates to an ultra-low power high-efficiency wireless digital receiver which executes integration of a correlation signal of a reception signal without relying heavily on a high-power device like an amplifier, thereby reducing power consumption and attaining high sensitivity and efficiency. The receiver includes a SAW correlator having an internal correlation code corresponding to a conversion code of a transmitter and correlating the internal correlation code with a reception signal to provide a correlation signal. The receiver also includes a rectifier for rectifying the correlation signal from the SAW correlator, and an integrator for integrating the signal rectified by the rectifier to detect a voltage of the signal from the rectifier. The receiver further includes a comparator for comparing the voltage detected by the integrator and a predetermined reference voltage to output a digital signal according to the comparison result.

### CLAIM OF PRIORITY

This application claims the benefit of Korean Patent Application No. 2005-64193 filed on Jul. 15, 2005, in the Korean Intellectual Property Office, the disclosure of which is incorporated herein by reference.

### BACKGROUND OF THE INVENTION

1. Field of the Invention

The present invention relates to a wireless digital receiver applied to a communication system, and more particularly, to an ultra-low power, high efficiency wireless digital receiver which executes integration of a correlation signal of a reception signal without relying heavily on a high-power device such as an amplifier, thereby decreasing power consumption while attaining high sensitivity and efficiency.

2. Description of the Related Art

In general, power consumption is one of the most important performance indicators in a wireless communication system. As there has been an increasing interest in ubiquitous network recently, the lifetime of a small battery has become a determining factor for the lifetime of sensor systems. Therefore, there will be continued efforts in research and development on the small batteries.

In particular, a wireless switch applied to home and factory automation is used for controlling simple operations such as turning a device on or off.

An exemplary receiver of such a conventional wireless switch is explained hereunder with reference to FIG. 1.

FIG. 1 shows blocks of the receiver of the conventional wireless switch.

In the receiver of the wireless switch shown in FIG. 1, a particular signal from an antenna ANT is detected by a SAW correlator 11 and the particular signal detected by the SAW correlator 11 is screened by an LC tank and charged by a charge circuit 12.

In addition, if a voltage charged by the charge circuit 12 is above a critical voltage, a critical discharger 13 is turned on to pass the detected voltage to a comparator 14. The comparator 14 compares the voltage Vd1 detected by the critical discharger 13 with a predetermined reference voltage Vref and is turned on as the detected voltage Vd1 surpasses the predetermined reference voltage Vref to provide the charged voltage as an output voltage.

In this receiver of the wireless switch, a particular signal is screened, and the particular voltage is accumulated for a sufficient time. When this accumulated voltage surpasses the reference voltage Vref, the switch is activated.

With this conventional method, however, supposing that the voltage is accumulated for a theoretically infinite amount of time, the voltage surpasses the reference voltage Vref due to unwanted signal such as offset, device mismatch and all kind of unpredictable noise occasionally, and in response, the switch is turned on erroneously each time. Therefore, the conventional switch has a problem of weak security as a wireless communication device.

Moreover, in the conventional technology, the voltage converted from the accumulated signal is discharged only after it surpasses the reference voltage. Thus, the conventional receiver can only perform simple switch operations, and its application range as a receiver having a certain data rate is limited.

### SUMMARY OF THE INVENTION

The present invention has been made to solve the foregoing problems of the prior art and therefore an object of certain embodiments of the present invention is to provide an ultra-low power wireless digital receiver in a communication system, which executes integration of a correlation signal of a reception signal without relying heavily on a high-power device such as an amplifier, thereby reducing power consumption and attaining high sensitivity and efficiency.

According to an aspect of the invention for realizing the object, there is provided an ultra-low power high efficiency wireless digital receiver including: a SAW correlator having an internal correlation code corresponding to a conversion code of a transmitter and correlating the internal correlation code with a reception signal to provide a correlation signal; a rectifier for rectifying the correlation signal from the SAW correlator; an integrator for integrating the signal rectified by the rectifier to detect a voltage of the signal from the rectifier; and a comparator for comparing the voltage detected by the integrator and a predetermined reference voltage to output a digital signal according to the comparison result.

The wireless digital receiver further includes an isolation amplifier installed at a front end of the SAW correlator to amplify a signal from an antenna by a predetermined gain and provide the amplified signal to the SAW correlator.

The wireless digital receiver further includes an RF amplifier for amplifying the correlation signal from the SAW correlator by a predetermined gain.

The integrator integrates the signal rectified by the rectifier in accordance with a clock signal.

The integrator charges the rectified signal if there is a signal rectified by the rectifier, and discharges an accumulated signal if there is no wanted rectified by the rectifier.

The integrator includes a ripple rejection circuit at an output end for eliminating radio frequency component of an output voltage.

The reference voltage includes first and second reference voltages in two trigger levels, and the comparator is composed of a Schmitt trigger having hysteresis characteristics using the first and second reference voltages.

The comparator outputs a digital signal “1” (valid) if a detected voltage is lower than the first reference voltage, and outputs a digital signal “0” (invalid) if the detected voltage is lower than the second reference voltage. In some technical or strategic purpose, the polarity of comparator output(Dout) can be reversed depending on whether the detected signal is valid or not.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a conventional wireless switch;

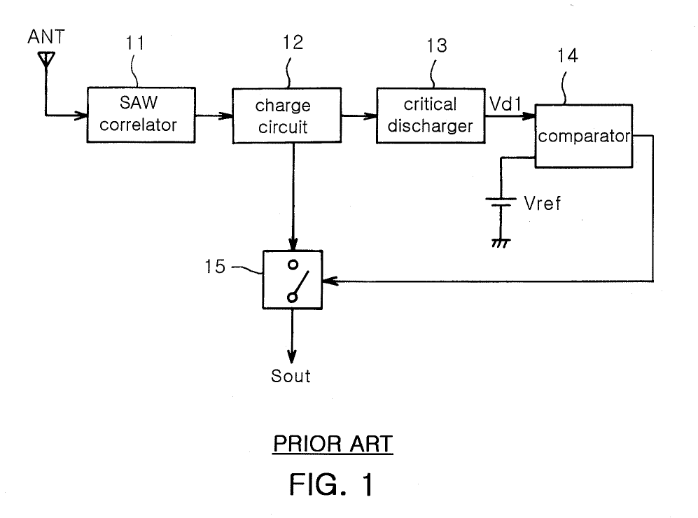

FIG. 2 is a block diagram illustrating a low-power wireless digital receiver according to the present invention;

FIG. 3 is a diagram illustrating waveforms of major signals of the wireless digital receiver shown in FIG. 3;

FIG. 4 is a diagram illustrating waveforms of signals for explaining the operation of an integrator shown in FIG. 2;

FIG. 5 is a graph showing the operational characteristics of the integrator and a comparator shown in FIG. 2;

FIG. 6 is a graph showing other operational characteristics of the comparator shown in FIG. 2; and

FIG. 7 is a flow diagram illustrating the operation of the wireless digital receiver according to the present invention

### DETAILED DESCRIPTION OF THE PREFERRED EMBODIMENT

Preferred embodiments of the present invention will now be described in detail with reference to the accompanying drawings. The same symbols are used throughout the different drawings to designate the same or similar components.

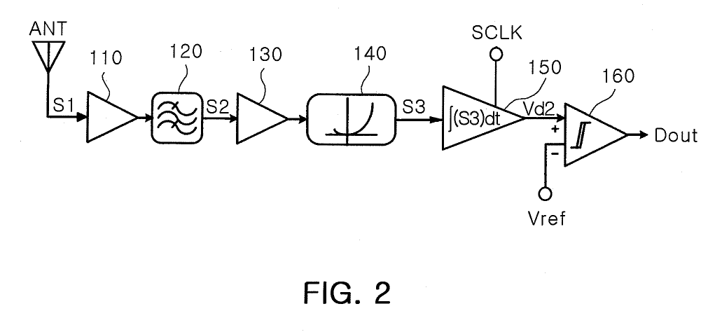

FIG. 2 is a block diagram illustrating a low power wireless digital receiver according to the present invention.

Referring to FIG. 2, the low-power wireless digital receiver according to the present invention includes an isolation amplifier 110, a SAW correlator 120, an RF amplifier 130, a rectifier 140, an integrator 150 and a comparator 160.

The isolation amplifier 110 amplifies a signal S1 from an antenna ANT by a predetermined gain and transmits the amplified signal to the SAW correlator 120.

The SAW correlator 120 has an internal correlation code corresponding to a conversion code of a transmitter, and correlates the internal correlation code with the reception signal S1 to provide a correlation signal S2 containing a plurality of peak voltages to the RF amplifier 130.

The RF amplifier 130 amplifies the correlation signal S2 from the SAW correlator 120 by a predetermined gain and provides the amplified signal to the rectifier 140. This amplifier can greatly reduce the susceptibility of overall system to noise.

The rectifier 140 rectifies the correlation signal S2 from the SAW correlator 120 to provide the signal to the integrator 150. Through this rectification process, the plurality of correlation peak voltages contained in the correlation signal S2 are rectified by half-wave so that only the correlation peak voltages higher than a reference level (e.g. 0 voltage) remain.

The integrator 150 integrates a signal S3 rectified by the rectifier 140 in accordance with a clock signal SCLK, detecting a voltage of the signal S3 from the rectifier 140 to provide the voltage to the comparator 160.

For example, when there is a signal S3 rectified by the rectifier 140 in accordance with the clock signal, the integrator 150 charges the signal S3 rectified by the rectifier 140. When there is no signal S3 rectified by the rectifier 140, the charged voltage is discharged because this accumulation is due to unwanted signal.

In the meantime, the integrator 150 may include a ripple rejection circuit at an output end for eliminating radio frequency component of an output voltage.

The comparator 160 compares the voltage Vd2 detected by the integrator 150 and a predetermined voltage Vref, and outputs a digital signal Dout according to this comparison result.

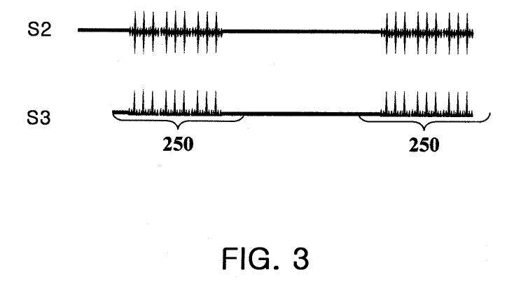

FIG. 3 is a diagram of waveforms of major signals of the wireless digital receiver shown in FIG. 2.

In FIG. 3, S2 is a signal outputted from the SAW correlator 120, containing about 250 correlation peak voltages, and S3 is a signal outputted from the rectifier 140.

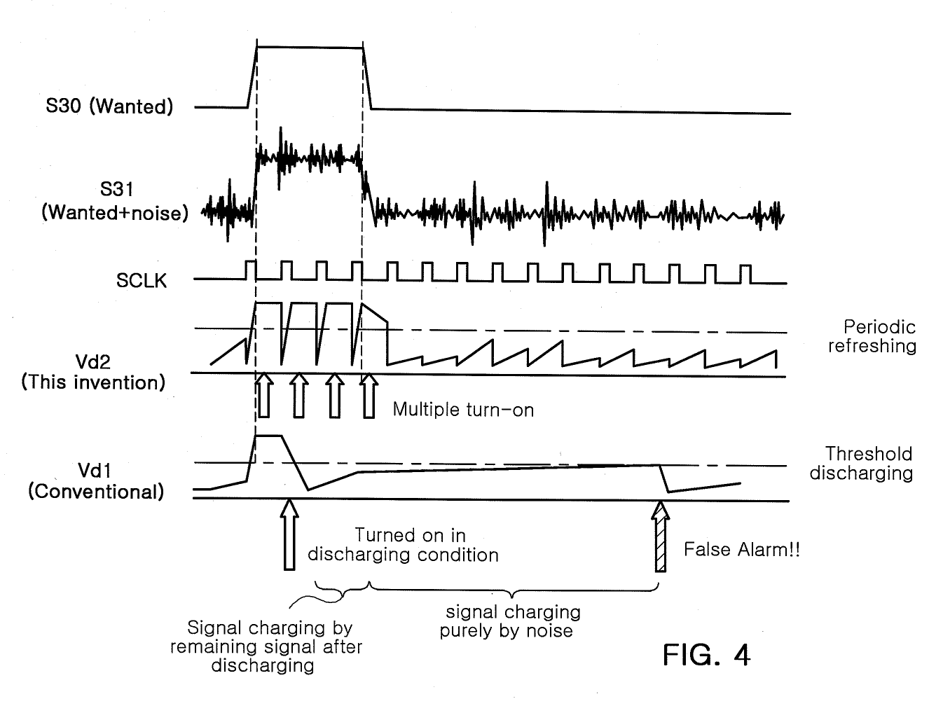

FIG. 4 is a diagram illustrating waveforms of signals for explaining the operation of the integrator shown in FIG. 2.

In FIG. 4, S30 is the waveform of a wanted signal without noise, S31 is the waveform of a wanted signal including noise, SCLK is the clock signal, Vd2 is the waveform of a voltage outputted from the integrator 150, and Vd1 is the voltage detected by the critical discharger 13 of the conventional wireless switch.

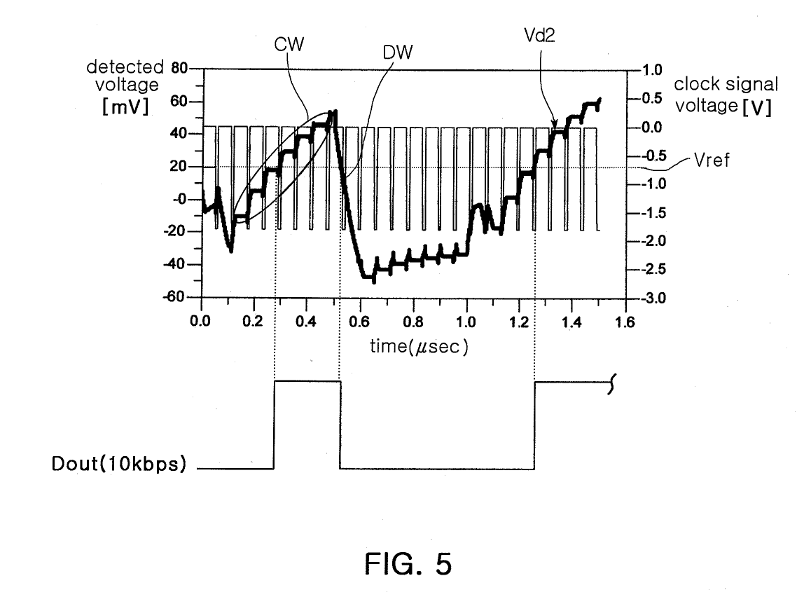

FIG. 5 is a graph showing operational characteristics of the integrator and the comparator shown in FIG. 2.

In FIG. 5, SCLK is the clock signal of the wireless digital receiver according to the present invention, Vd2 is the voltage outputted from the integrator 150, and Vref is the reference voltage of the comparator 160. Dout is the output signal of the comparator 160, CW is the charge waveform and DW is the discharge waveform.

Referring to FIGS. 2 to 5, the reference voltage includes first and second reference voltages Vref1 and Vref2 in two trigger levels and the comparator 160 is composed of a Schmitt trigger having hysteresis characteristics using the first and second reference voltages Vref1 and Vref2.

The comparator 160 outputs a digital signal “1” if the detected voltage is higher than the first reference voltage Vref1, and outputs a digital signal “0” if the detected voltage Vd2 is lower than the second reference voltage.

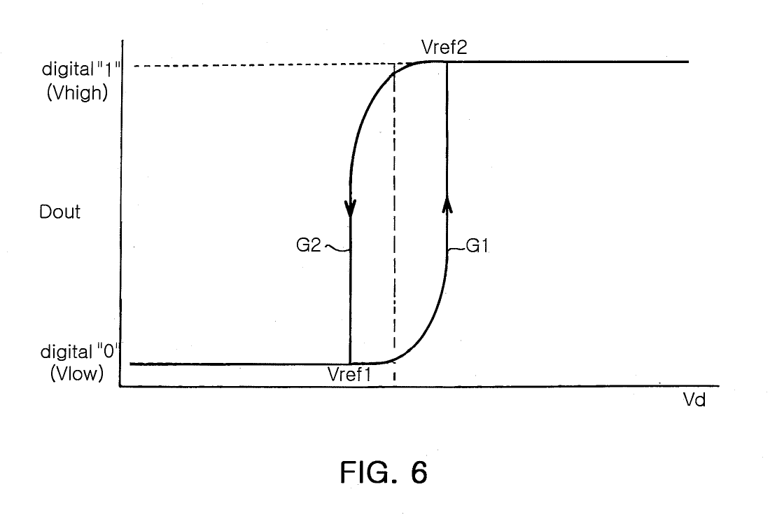

FIG. 6 is a graph showing other operational characteristics of the comparator shown in FIG. 2.

In FIG. 6, the vertical axis indicates the output voltage (mV), and the horizontal axis indicates the voltage (V). +600 [mV] is a high level of the output voltage, which corresponds to the digital signal “1”, whereas −600 [mV] is a low level of the output voltage which corresponds to the digital signal “0”. G1 is output characteristics exhibited while the detected voltage is increasing, and G2 is output characteristics exhibited while the detected voltage is decreasing. That is, while the detected voltage Vd2 is increased (indicated with G1), the output voltage maintains V-low until Vd2>Vref2. Conversely, while the detected voltage Vd2 is decreased (indicated with G2), the output voltage maintains V-high until Vd2<Vref1. With this feature, the output value can be prevented from being affected by sudden increase or decrease in the voltage due to thermal noise or switching noise. Thus, additional devices such as a low pass filter are not required.

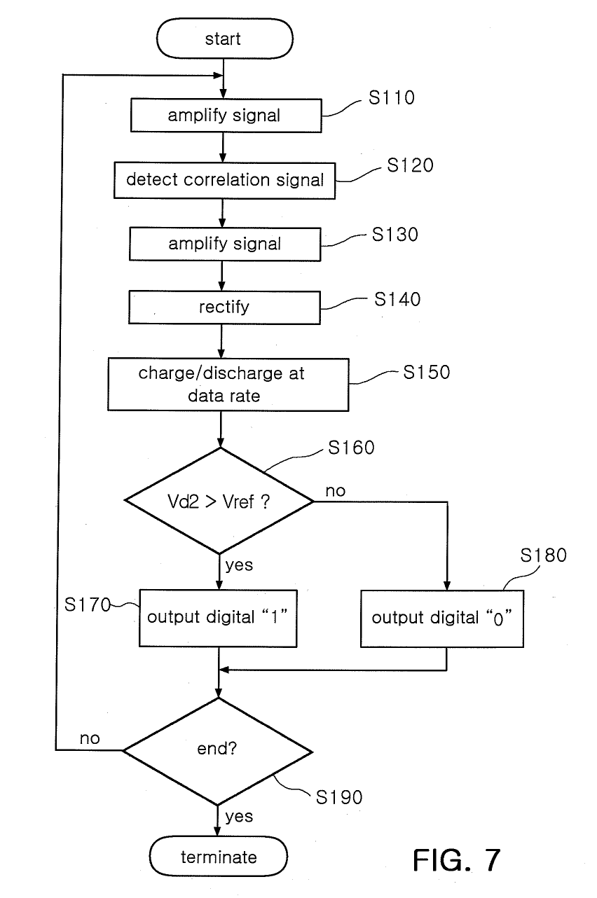

FIG. 7 is a flow diagram illustrating the operation of the wireless digital receiver according to the present invention.

The operations and effects of the present invention will now be explained in detail with reference to the accompanying drawings.

Explaining the operation of the wireless digital receiver with reference to FIGS. 2 to 7, an isolation amplifier 110 of the wireless digital receiver of the invention amplifies a signal S from an antenna ANT by a predetermined gain to transmit the amplified signal to a SAW correlator 120 (S110, FIG. 7). Here, the signal received from the antenna ANT is a signal coded by a conversion code at a corresponding transmitter.

Next, the SAW correlator 120 correlates the reception signal S from the isolation amplifier 110 with an internal correlation code to transmit a correlation signal S2 containing a plurality of correlation peak voltages to an RF amplifier 130 (S120, FIG. 7).

More specifically, referring to FIGS. 2 and 3, the SAW correlator 120 outputs a high level signal shown in FIG. 3 if an RF signal received through the antenna ANT is a signal received from a transmitter having the conversion code corresponding to the internal correlation code. At this time, the correlation signal contains an infinite number of correlation peak voltages with a time interval equivalent to the correlation period (e.g. 250 peak voltages in one correlation period).

On the contrary, if the RF signal received from the antenna ANT is a signal received from a transmitter having a conversion code that does not correspond to the internal correlation code, the SAW correlator 120 outputs a low level (almost 0) signal. Here, the SAW correlator can be realized using a SAW matched filter.

Next, the RF amplifier 130 amplifies the correlation signal S2 from the SAW correlator 120 by a predetermined gain to output the amplified signal to a rectifier 140 (S130, FIG. 7). The rectifier 140 rectifies the correlation signal S2 to output the rectified signal S3 to an integrator 150 (S140, FIG. 7).

Next, the integrator 150 integrates the signal S3 rectified by the rectifier 140 and detects the voltage of the signal S3 from the rectifier 140 to output a voltage to the comparator 160 (S150, FIG. 7). That is, the integrator 150 integrates the correlation signal containing an infinite number of correlation peak voltages with a time interval (e.g. 400 ns) equivalent to the correlation period.

The operations of the integrator 150 according to the present invention will now be explained with reference to FIG. 4.

In FIG. 4, if noise is not included in the signal inputted into the integrator 150, the signal would have the waveform “S30”, but typically noise is included in a signal, and thus the signal inputted into the integrator 150 has the waveform “S31”.

When the integrator 150 receives a signal having a waveform like S30 shown in FIG. 4, it repeats charging and discharging in accordance with the clock signal SCLK. More specifically, the integrator 150 charges at a low level of the clock signal SCLK, and discharges at a high level of the clock signal SCLK, thus outputting a voltage having a waveform like Vd2 in FIG. 4.

As described above, since the integrator 150 repeats charging and discharging in accordance with the clock signal SCLK, even if the signal contains noise, noise is not continuously charged. Before the charged value reaches the critical value in accordance with the clock signal, the integrator 150 discharges, thus preventing false alarms.

As indicated by “Vd1” in FIG. 4, the conventional switch may have false alarms because the noise contained in the signal is continuously charged, whereas the low-power digital receiver according to the present invention can prevent such false alarms.

Explaining in detail with reference to FIGS. 2 to 5, the integrator 150 repeats charging and discharging in accordance with the clock signal SCLK of the receiver 150.

For example, the integrator 150 executes integration at a data rate of about 10 kbps (100 us), and if there is a rectified signal S3 by the rectifier 140, the integrator 150 executes data integration to charge the rectified signal S3 in a stepwise fashion as shown by the charge waveform in FIG. 5. At this time, the level of the charged voltage is increased stepwise.

On the contrary, if there is no rectified signal S3 by the rectifier 140, the charged voltage is quickly discharged before its level surpasses reference voltage Vref as shown by the discharge waveform DW in FIG. 5.

In the meantime, if a ripple rejection circuit is provided at the output end of the integrator 150, the integrator 150 can eliminate radio frequency before inputting the charged signal to the comparator 160, thereby decreasing the roughened component due to the correlation and integration characteristics. This prevents loss of data due to sudden interference of large noise. The ripple rejection circuit can be composed of a low pass filter.

Next, the comparator 160 compares the detected voltage Vd2 by the integrator 150 and the predetermined reference voltage Vref to output a digital signal Dout according to the comparison result (S160, FIG. 7).

Explaining this process with reference to FIGS. 2 to 5, the comparator 160 outputs a digital signal “1” if the detected voltage Vd2 is higher than the reference voltage Vref (S170, FIG. 7), and outputs the digital signal “0”, if the detected voltage Vd2 is lower than the reference voltage Vref, as shown in FIG. 5 (S180, FIG. 7).

At this time, the comparator 160 can be realized by a Schmitt trigger having hysteresis characteristics. With reference to FIGS. 2 to 6, the reference voltage Vref includes first and second reference voltages Vref1 and Vref2 in two trigger levels, and the comparator 160 can be composed of a Schmitt trigger having hysteresis characteristics using the first and second reference voltages Vref1 and Vref2. In this case, the comparator 160 outputs the digital signal “1” if the detected voltage Vd2 is higher than the first reference voltage Vref1.

On the other hand, if the detected voltage Vd2 is lower than the second reference voltage Vref2, the comparator 160 outputs the digital signal “0”. Using this Schmitt trigger, the comparator is desensitized to noise since noise voltages at the input side cause errors in the output side due to positive feedback for hysteresis of Schmitt trigger.

As described above, the comparator outputs different digital signals respectively for a signal above a certain level (“1”) or a signal below the certain level (“0”), thus enabling digital communication with the wireless digital receiver according to the present invention. This process is repeated until the applied system is terminated (S190, FIG. 7).

As discussed above, the integrator according to the present invention not only executes integration but alternates between charging and discharging, thus freely setting a desired data rate. That is, the receiver not only functions as a switch but also enables data communication. The data rate of the communication system is closely related to the correlation characteristics of the SAW correlator and the bandwidth of the integrator. The communication method is limited to on-off keying (OOK), but the receiver has a great advantage in that it is efficient due to its simple structure and can operate the system with ultra-low power consumption.

According to certain embodiments of the present invention set forth above, a wireless digital receiver applied to a communication system executes integration for a correlation signal of a reception signal in accordance with a clock signal without relying heavily on a high-power device like an amplifier, thereby reducing power consumption and attaining high sensitivity and efficiency.

That is, voltage gains obtained through the integration process in which charging and discharging is repeated in accordance with the clock signal can reduce the burden of power gains demanded from an RF amplifier by the entire receiver, thereby reducing the power consumption of the receiver as much. Further, the charging and discharging operations in accordance with the clock signal can be utilized for synchronization, and thus there is no need for an additional synchronization circuit. In addition, the charged value by noise is discharged before reaching a critical value, thus preventing false alarms by noise. Moreover, the invention advantageously allows increased integration gains if the data rate is lower in relation to the correlation period of the correlation signal.

While the present invention has been shown and described in connection with the preferred embodiments, it will be apparent to those skilled in the art that modifications and variations can be made without departing from the spirit and scope of the invention as defined by the appended claims.

What is claimed is:

1. An ultra-low power, high efficiency wireless digital receiver comprising:
a SAW correlator having an internal correlation code corresponding to a conversion code of a transmitter and correlating the internal correlation code with a reception signal to provide a correlation signal;
a rectifier for rectifying the correlation signal from the SAW correlator;
an integrator for integrating the signal rectified by the rectifier to detect a voltage of the signal from the rectifier; and
a comparator for comparing the voltage detected by the integrator and a predetermined reference voltage to output a digital signal according to the comparison result.

2. The ultra-low power, high efficiency wireless digital receiver according to claim 1, further comprising an isolation amplifier installed at a front end of the SAW correlator to amplify a signal from an antenna by a predetermined gain and provide the amplified signal to the SAW correlator.

3. The ultra-low power, high efficiency wireless digital receiver according to claim 1, further comprising an RF amplifier for amplifying the correlation signal from the SAW correlator by a predetermined gain.

4. The ultra-low power, high efficiency wireless digital receiver according to claim 1, wherein the integrator integrates the signal rectified by the rectifier in accordance with a clock signal.

5. The ultra-low power, high efficiency wireless digital receiver according to claim 1, wherein if there is a signal rectified by the rectifier, the integrator charges the rectified signal, and if there is no signal rectified by the rectifier, the integrator discharges an accumulated signal.

6. The ultra-low power, high efficiency wireless digital receiver according to claim 1, wherein the integrator includes a ripple rejection circuit at an output end for eliminating radio frequency component of an output voltage.

7. The ultra-low power, high efficiency wireless digital receiver according to claim 1, wherein the reference voltage includes first and second reference voltages in two trigger levels, and
the comparator comprises Schmitt trigger having hysteresis characteristics using the first and second reference voltages.

8. The ultra-low power, high efficiency wireless digital receiver according to claim 7, wherein the comparator outputs a digital signal “1” if a detected voltage is lower than the first reference voltage, and outputs a digital signal “0” if the detected voltage is lower than the second reference voltage.
